(19) United States
(12) Patent Application Publication
(10) Pub. No.: US 2025/0339792 A1
(43) Pub. Date: Nov. 6, 2025

(54) SYSTEMS AND METHODS FOR CONVERSION TO ELECTRICAL HEAT-DRIVEN PETROLEUM SEPARATION

(71) Applicant: Profire Energy, Inc., Lindon, UT (US)

(72) Inventors: Michael D. Bozman, Spruce Grove (CA); Patrick D. Fisher, Spruce Grove (CA)

(73) Assignee: Profire Energy, Inc., Lindon, UT (US)

(21) Appl. No.: 19/185,941

(22) Filed: Apr. 22, 2025

Related U.S. Application Data
(60) Provisional application No. 63/642,468, filed on May 3, 2024.

(51) Int. Cl. B01D 17/04; H05B 3/42

(52) U.S. Cl. CPC B01D 17/042; H05B 3/42

(57) ABSTRACT

Systems and methods are disclosed for conversion of an in-situ heater treater from gas-fire to electrical heat-driven separation (and for new-con build) whereby the fire tube is reused, reducing labor, and an energy efficient electrical heating system is installed providing for a reduced carbon footprint. A thermoconductive medium is employed to permit higher heat production without the risks associated with overheating at the petroleum surface area.

### RELATED APPLICATIONS

This application claims benefit of priority under 35 U.S.C. 119(e) to U.S. Provisional Patent Application No. 63/642,468, titled “SYSTEMS AND METHODS FOR CONVERSION TO ELECTRICAL HEAT-DRIVEN PETROLEUM SEPARATION,” filed May 3, 2024. The subject matter of each of the foregoing applications is hereby incorporated herein by reference to the extent such subject matter is not inconsistent herewith.

### TECHNICAL FIELD

The present disclosure relates generally to petroleum separation, and more specifically, to petroleum separation using an electrically-driven heat source.

### BACKGROUND

Historically, field petroleum separation has been accomplished using gas-fired heater treaters. While convenient, a gas-fired heater treater increases the carbon footprint of petroleum extraction and transport. Current efforts to convert heater treaters to electric heating units require major modification of the heater treater itself and fail to adequately and efficiently deal with contact surface heat issues involved with petroleum while also being thermally inefficient and difficult to maintain. What is needed is a more efficient conversion to an electric heat source that addresses challenges and shortcomings of the currently available solutions and technology.

### SUMMARY

The present disclosure provides embodiments of assemblies, processes, systems, and/or kits for conversion of a heater treater from a combustible system to an electrically heated system.

### BRIEF DESCRIPTION OF THE DRAWINGS

Aspects and advantages of embodiments of the present disclosure will be apparent from the following detailed description of preferred embodiments, which proceeds with reference to the following accompanying drawings.

FIG. 1 is a cutaway side view of a typical heater treater prior to conversion, according to an embodiment of the present disclosure.

FIG. 2A is a cutaway side view of an electric heater treater system (“EHTS”) at a preliminary stage of conversion, according to an embodiment of the present disclosure.

FIG. 2B is a cutaway side view of the EHTS of FIG. 2A, according to an embodiment of the present disclosure, and post conversion.

FIG. 3 is a cutaway side view of an EHTS, according to an embodiment of the present disclosure.

FIG. 4 is a method for conversion of a combustion-driven heater treater to an electrically-driven heater treater system (“EHTS”), according to an embodiment of the present disclosure.

### DETAILED DESCRIPTION OF PREFERRED EMBODIMENTS

The present disclosure provides for conversion of a heater treater from a combustible system to an electrically heated system. The disclosed conversion assemblies and processes can mitigate contact surface heat concerns, can be more thermally efficient, and can provide for simpler and/or easier maintenance. The disclosed conversion assemblies and processes can avert and even avoid costly modification of the heater treater vessel by retaining the fire tube, which can also reduce labor to perform the conversion. The disclosed conversion assemblies and processes can also reduce the waste produced in conversion. Converting to an electric heat source allows use of an electric power grid, potentially employing renewable energy, rather than combustion of gases, thereby reducing the overall carbon footprint involved in producing and transporting petroleum from an extraction site to a processing facility.

Embodiments of the present disclosure can reduce the carbon footprint associated with petroleum extraction and transport. Conversion according to the present disclosure can be more cost-effective and efficient than presently available means of transitioning to electrically heated heater treaters, with a substantial reduction in the amount of labor to perform the conversion and a reduction in waste produced, further reducing the net carbon cost. Post conversion, according to embodiments of the present disclosure, the electrically driven heater treater is easier to maintain than any present system. Furthermore, the post-conversion heater treater may mitigate concerns regarding contact surface heating of petroleum while simultaneously enabling more efficient thermal performance.

It should be apparent to a person having ordinary skill in the art that, while the main approach of the description of the present disclosure is that of converting an installed heater treater, the disclosure equally applies to and includes a new construction (“new-con”) heater treater.

As used herein, the term “emulsion” refers to a petroleum compound, such as, e.g., crude, capable of being separated into a plurality of products, which may include gaseous (gas), oil, solids, and water.

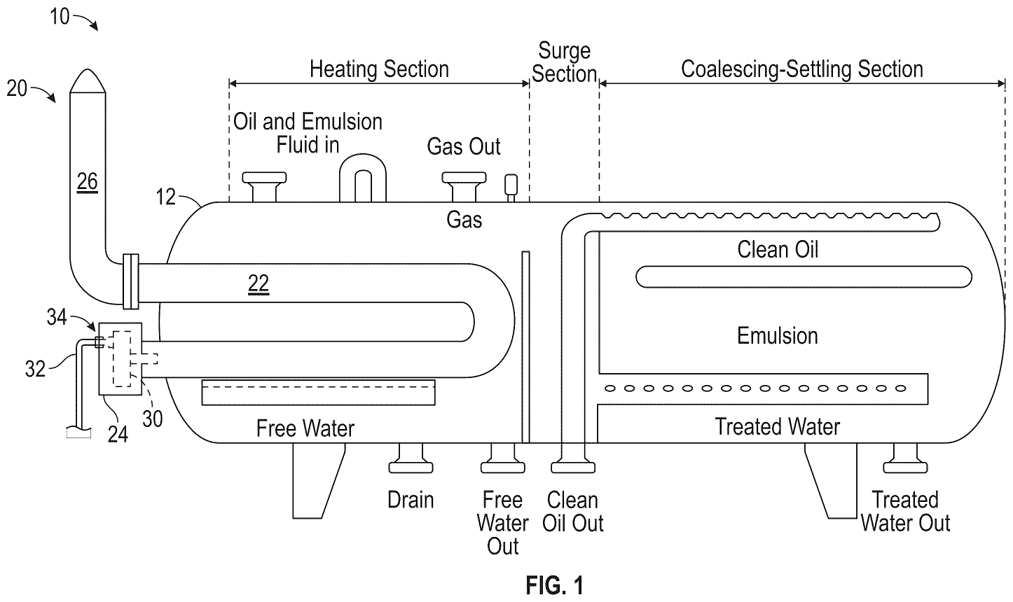

FIG. 1 is a cutaway side view of a typical combustion-driven heater treater 10 prior to conversion, according to an embodiment of the present disclosure. The heater treater 10 comprises a vessel 12 within which a petroleum emulsion is separated. A petroleum emulsion (also referenced herein as simply “emulsion”) can be a petroleum product or petroleum compound, such as crude, capable of being separated into a plurality of products, which may include gaseous (gas), oil, solids, and water. The heater treater 10 can be used to separate a petroleum emulsion into two or more components or phases (e.g., gas, oil, solids, water, etc.) by application of heat. The heater treater 10 of FIG. 1 can separate petroleum emulsion into at least gas, oil, and water. The vessel 12 can include various access ports for providing emulsion in, and for outputting gas, water, and oil.

The heater treater 10 further comprises a heating unit 20 to provide heat that is applied to the emulsion. The heating unit 20 is a combustible heating unit. The heating unit 20 comprises a fire tube 22, an igniter box 24, and an exhaust stack 26. The fire tube 22 can be integral to the vessel 12, extending through a wall of the vessel into an interior region of the vessel where emulsion may substantially surround or otherwise encompass at least a portion of the fire tube 22. An igniter 30 is housed within the igniter box 24 and positioned at a lower portion of the fire tube 22. The igniter 300 can be disposed outside the wall of the vessel 12 at an end of the fire tube that protrudes outside of the vessel 12. A fuel supply 32 enters the igniter box 24 through a port 34 to couple with and/or otherwise provide fluid to the igniter 30 for the combustion that is accomplished by the combustible heating unit 20. The heating unit 20 produces heat through combustion of fuel provided by the fuel supply 32 and the heat passes through the fire tube 22 to be transferred to an emulsion within the vessel 12. The exhaust from combustion can pass through the fire tube 22 to the exhaust stack 26.

Typical combustion-driven heater treaters such as the heater treater 10 of FIG. 1 are effective and provide a proper amount of heat for heating the emulsion within the vessel to separate the emulsion into components. However, a combustion-driven heater treater has a more impactful carbon footprint. Thus, electrical-driven heating units may be desirable to decrease the carbon footprint of petroleum separation. The present disclosure provides assemblies, processes, systems, kits, and other embodiments for conversion of a combustion-driven heater treater to be electrically driven. The present disclosure provides assemblies, processes, systems, kits, and other embodiments for in-situ conversion of the heater treater.

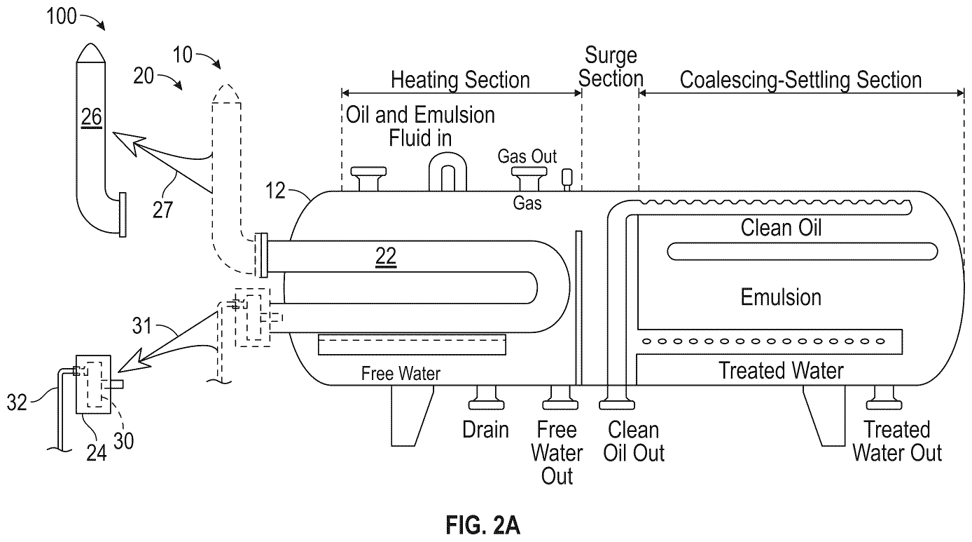

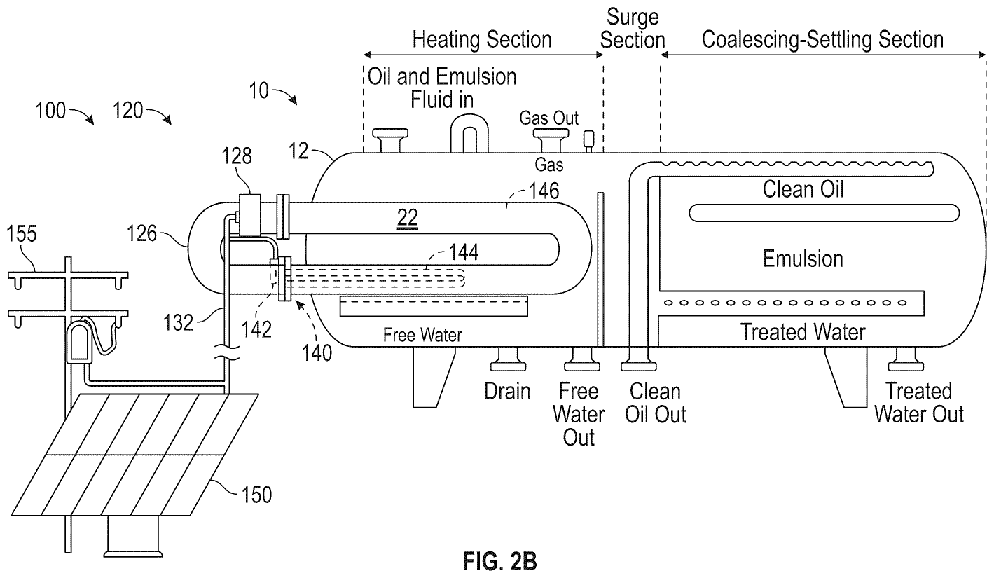

FIG. 2A is a cutaway side view of an electric heater treater system (“EHTS”) 100 at a preliminary stage of conversion, according to an embodiment of the present disclosure. The heater treater 10, the vessel 12, the fire tube 22, and the igniter box 24 are shown for reference. To convert an existing heater treater 10 to an EHTS 100, the exhaust stack 26 is removed 27, and the igniter 30 and fuel supply 32 are also removed 31. Notably, the fire tube 22 is retained (e.g., in situ). The fire tube 22 remains integral to or otherwise integrated with the vessel 12, passing in through a wall of the vessel 12 into an inner space of the vessel 12 and passing out through the wall of the vessel 12. In one embodiment of the present disclosure, the igniter box 24 can also be retained. Once the exhaust stack 26, the igniter 30, and the fuel supply 32 have been removed 27, 31, any other maintenance required by company protocols may be performed on the fire tube 22 (and, where appropriate, the igniter box 24).

FIG. 2B is a cutaway side view of the EHTS 100 of FIG. 2A, according to an embodiment of the present disclosure, and post conversion. The heater treater 10, the vessel 12, and the fire tube 22 are shown for reference. The EHTS 100 comprises an electrical heating unit 120. The electrical heating unit 120 can include a fire tube extension 126 (or fire tube extender), a circulation pump 128 and an electrical heater 140.

The fire tube extension 126 is shown coupled to the fire tube 22. The fire tube extension 126 can be configured to fluidly couple an exhaust end at an upper portion of the fire tube 22 to an igniter end at the lower portion of the fire tube 22, to route or otherwise direct thermoconductive material (e.g., fluid) from the exhaust end of the fire tube to the igniter end of the fire tube. The fire tube extension 126 can include additional tubing (e.g., one or more extensions of tubing) and one or more fittings to couple the additional tubing to one or more ends of the fire tube 22 and/or to the circulation pump 128. In an embodiment, the circulation pump 128 is integral to the fire tube extension 126. In an embodiment, the fire tube extension 126 can include a first extension tube to extend from a first side (e.g., an inlet) of the circulation pump 128 to one opening of the fire tube 22 and a second extension tube to extend from a second side (e.g., an outlet) of the circulation pump 128 to a second opening of the fire tube 22.

The circulation pump 128 is configured to circulate a thermoconductive material (e.g., a fluid) through the fire tube 22. In the embodiment of FIG. 2B, the circulation pump 128 is coupled at an upper portion of the fire tube extension 126 and between the upper portion of the fire tube extension 126 and an upper portion of the fire tube 22. A lower portion of the fire tube extension 126 is coupled to a lower portion of the fire tube 22. In one embodiment, the igniter box may be retained and re-installed between the lower portion of the fire tube extension 126 and the lower portion of the fire tube 22 (see the igniter box 24 in FIG. 2A). By way of non-limiting example, in one embodiment, the circulation pump 128 may be housed in the igniter box 22 rather than disposed between the upper portion of the fire tube extension 126 and the upper portion of the fire tube 22.

The electric heater 140 can be designed or otherwise configured to heat a thermoconductive material (e.g., a fluid). The electric heater 140 may configured to be positioned or otherwise disposed at an opening of the fire tube 22. The electric heater 140 may include one or more heating elements 144 that can be positioned through the opening and/or within the fire tube 22. The electric heater 140 may be mounted at the opening of the fire tube 22 to be secured and/or affixed relative to the fire tube 22. In FIG. 2B, the electrical heater 140 is installed within the lower portion of the fire tube 22. A portion of the electrical heater 140 may be disposed within the lower portion of the fire tube extension 126. In one embodiment, a portion of the electrical heater 140 may be disposed within the igniter box. The electrical heater 140 comprises a terminal 142 and one or more heating elements 144.

The fire tube 22 contains a thermoconductive medium 146. The thermoconductive medium 146 can be an appropriately viscous liquid, such as, triethylene glycol (sometimes known in the art as triglycol or TEG), or other efficient thermal conductor. Examples of appropriately viscous liquid that can serve as (or as a component of) the thermodonductive medium 146 include, but are not limited to, triethylene glycol, mineral oil, ethylene glycol, propylene glycol, glycerin, and thermal oils.

A power line 132 may be used to bring power to the electrical heater 140 and the circulation pump 128. The power line 132 couples with the terminal 142 of the electrical heater 140. Power may be supplied by coupling the power line 132 to a local power grid 155. To an extent that renewable energy supplies the local power grid 155 or is otherwise available, the electrical heater 140 may be likewise powered by renewable energy. Power may also be supplied by coupling the power line 122 to a solar power system 150 or other renewable energy source (e.g., a solar farm, a wind farm, a tidal harness, etc.), such as may be installed near the site of the heater treater 10. In the embodiment of FIG. 2B, the power line 132 is shown coupled to both a solar power system 150 and a local grid 155, suggesting either or both couplings may be employed at any given site. A local generator, wind, a battery, or other storage are also potential sources of power for powering the electrical heater 140 and/or circulation pump 128.

When operational, the EHTS 100 energizes the electrical heater 140, which heats the thermoconductive medium 146 to an appropriate temperature for operation of the heater treater 10 (which may vary based on the composition of the emulsion). The circulation pump 128 causes the thermoconductive medium 146 to circulate throughout the fire tube 22, passing over the heating element(s) 144 to gain heat which is then conducted to the fire tube 22, thereby heating the emulsion. A unique feature of the EHTS 100 is the immersion of the electrical heating element(s) 144 in the thermoconductive medium 146, which allows operating the heating element(s) 144 at a higher temperature than is feasible in existing systems. The thermoconductive medium 146 conducts heat from the heating element(s) 144 to the fire tube 22 while also distributing that heat across a contact surface area that is orders of magnitude greater an area than in existing systems. This permits more efficient operation of the heating element(s) 144 while minimizing and/or obviating the risks of overheating at the contact surface area of the petroleum.

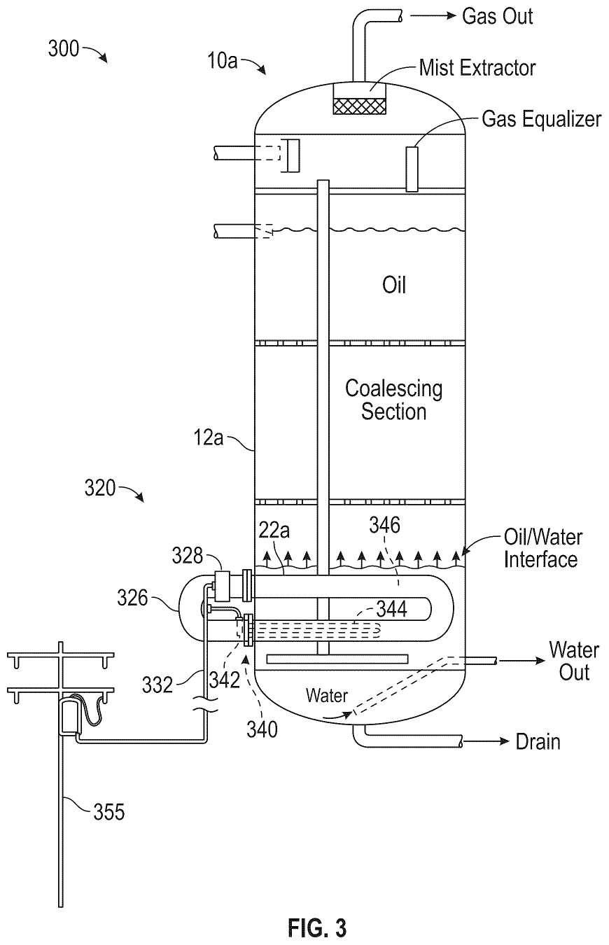

FIG. 3 depicts an embodiment of an EHTS 300 that resembles the EHTS 100 described above in certain respects. Accordingly, like features are designated with like reference numerals, with the leading digit(s) incremented to “3.” For example, the embodiment depicted in FIG. 3 includes a fire tube extension 326 that may, in some respects, resemble the fire tube extension 126 of FIG. 2B. Relevant disclosure set forth above regarding similarly identified features thus may not be repeated hereafter. Moreover, specific features of the EHTS 100 and related components shown in FIG. 2B may not be shown or identified by reference numeral in the drawings or specifically discussed in the written description that follows; however, such feature may clearly be the same, or substantially the same, as features depicted in other embodiments and/or described with respect to such embodiments. Accordingly, the relevant descriptions of such features apply equally to the features of the EHTS 300 and related components depicted in FIG. 3. Any suitable combination of the features, and variations of the same, described with respect to the EHTS 100 and related components in FIG. 2B can be employed with the EHTS 300 and related components of FIG. 3, and vice versa. This pattern of disclosure applies equally to further embodiment depicted in subsequent figures and described hereafter, wherein the leading digit(s) may be further incremented.

FIG. 3 is a cutaway side view of an electrically-driven heater treater system (“EHTS”) 300, according to an embodiment of the present disclosure. The EHTS 300 of

FIG. 3 can be similar in at least some respects to the EHTS 100 of FIGS. 2A and 2B. In the embodiment of FIG. 3, the heater treater 10a is vertical rather than horizontal (for comparison, see the heater treater 10 in FIGS. 1-2B). The vertical heater treater 10a of the EHTS 300 comprises a vessel 12a and an electrical heating unit 320. The electrical heating unit 320 can include a fire tube 22a which has been retained during a conversion from gas-fired to electrically-driven. The electrical heating unit 320 can further include a fire tube extension 326, a circulation pump 328, an electric heater 340, and a thermoconductive medium 346. The electric heater 340 can include a terminal 342 and one or more heating elements 344. A power line 332 provides electricity to the electric heater 340 and the circulation pump 328. The power line 332 can couple to a local electrical grid 355.

In the foregoing embodiments, a circulation pump is described as disposed between an upper portion of a fire tube extension and an upper portion of a fire tube; however, this is for convenience of the disclosure only, and not by way of limitation (see the circulation pump 128, 328, the fire tube extension 126, 326, and the fire tube 22 of FIGS. 2A and 2B and the fire tube 22a of FIG. 3). The disclosure anticipates other locations for the circulation pump, for example at or near a midpoint of the fire tube extension, between a lower portion of the fire tube extension and a lower portion of the fire tube, between a lower portion of the fire tube extension and the igniter box (when retained), within the igniter box (when retained), within a portion of the fire tube, etc. (see the igniter box 24 in FIG. 2A).

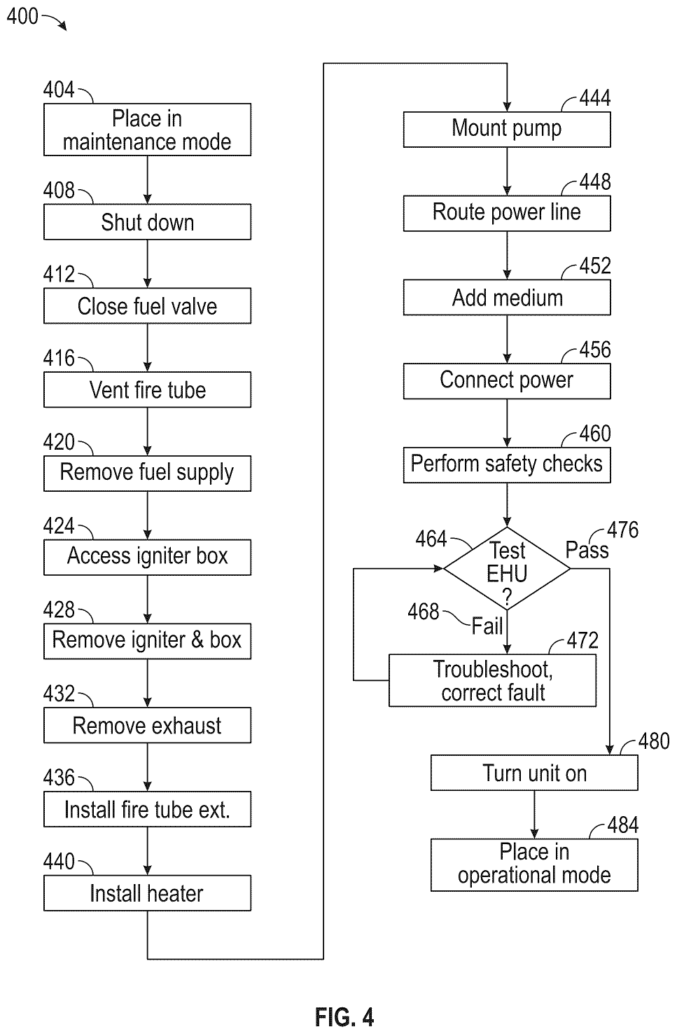

FIG. 4 is a method 400 for conversion of a combustion-driven heater treater to an electrically-driven heater treater system (“EHTS”), such as the EHTSs 100, 300 of FIGS. 2B and 3, according to an embodiment of the present disclosure. The site (including upstream interdependent stations) is placed 404 in a maintenance mode. With the site in maintenance mode, shut down 408 the heater treater. Close 412 each fuel valve between a fuel source and the fire tube igniter. Vent 416 the fire tube to clear combustible gas and allow the fire tube to cool. Following appropriate safety protocols, remove 420 the fuel supply system. Access 424 the igniter box. This may involve opening an access panel, removing a cover, or removing the igniter box. Remove 428 the igniter and the igniter box. Remove 432 an exhaust stack. Install 436 a fire tube extension.

Install 440 the electric heater (e.g., an electric heating terminal and electric heating elements). Installing 440 the electric heater can include positioning one or more electric heating element(s) of the electric heater to be disposed within or to extend at least partially into the fire tube. To install 440 the electric heater, it may be useful to mount a bracket on/in the fire tube extension, the fire tube, or both, to accept the terminal or a flange of the electric heater. Mount 444 the circulation pump. Route 448 the power line, including coupling a connector at the circulation pump and/or at the electric heater. Add 452 thermoconductive medium to the fire tube, and seal the electrical heating unit and test for leakage. Connect 456 the power line to a source of power, such as to a local electrical grid, etc. Perform 460 appropriate safety checks. Test 464 the electric heater for function and compliance with target parameters. If the electric heater fails 468 in testing, perform troubleshooting 472 and correct any fault(s) found. Test 464 the electric heater. Repeat until the electric heater passes. When the electric heater passes 476, turn on 480 the unit. When the unit reaches operating parameters, place 484 the site in operational mode.

The method 400 of FIG. 4 lists a series of functions in a given order for convenience of the disclosure and not by way of limitation. The disclosure anticipates variations in the order of functions such as adding 452 the thermoconductive medium prior to routing 448 a power line, after connecting 456 to power, or after performing 460 at least some safety checks, etc. The order of some functions incorporates field-standards such as, removing 432 the exhaust several steps after venting 416 the fire tube to allow for the exhaust to clear combustibles, airborne hazards, and to cool sufficiently for handling; however, this order is not by way of limitation of the disclosure and may vary according to safety or other protocols. Other functions may be performed in any appropriate order without limitation. It will be apparent to a person having ordinary skill in the art that the method for conversion of a gas-powered heater treater to an EHTS lends itself readily to simple modification for an application to a new-con build of an EHTS without detriment to the present disclosure.

### EXAMPLES

Some examples of embodiments of the present disclosure are provided below.

Example 1. A method to convert or retrofit a petroleum heater to operate using electric heating, comprising: removing, uninstalling, or disconnecting a fuel supply from a combustible heating unit; removing, uninstalling, or disassembling an igniter of the combustible heating unit from a fire tube of the combustible heating unit, and maintaining the fire tube in position; installing an electric heater to position electric heating elements of the electric heater within the fire tube; mounting a pump to an opening of the fire tube to circulate, propel, or pump fluid (e.g., a thermoconductive medium) through the fire tube, to flow the thermoconductive medium past the heating elements to absorb heat; connecting a fire tube extender to fluidly couple an exhaust end (e.g., exhaust opening, or output opening) at an upper portion (or an exhaust portion) of the fire tube to an igniter end (e.g., an igniter opening) at a lower portion (or combustion portion) of the fire tube; and add a thermoconductive medium to fill the fire tube (and fire tube extender).

Example 2. The method of example 1, further comprising removing an exhaust stack from the exhaust end of the fire tube.

Example 3. The method of example 1, wherein installing the electric heater includes connecting a power supply (e.g., an electricity source) to the electric heater and the pump.

Example 4. A kit to convert or retrofit a petroleum heater treater to operate using electric heating, comprising: an electric heater to be mounted at an opening of a lower portion of a fire tube to position electric heating elements of the electric heater at least partially within the fire tube; a pump to circulate, propel, or drive fluid (e.g., a thermoconductive medium) through the fire tube and to flow the thermocuductive medium past the heating elements to absorb heat; and a fire tube extender to fluidly couple an exhaust end (e.g., an exhaust opening, or output opening) at an upper portion (or exhaust portion) of the fire tube to an igniter end (e.g., an igniter opening) at the lower portion (or combustion portion) of the fire tube; and a thermoconductive medium to fill the fire tube and fire tube extender.

Example 5. A system or device to electrically heat a petroleum heater treater, comprising: an electric heater mounted at an opening of a lower portion of a fire tube to position electric heating elements of the electric heater at least partially within the fire tube of the petroleum heater treater; a thermoconductive medium at least substantially filling the fire tube, and to receive heat from the electric heating elements of the electric heater, and to transfer the heat to the fire tube for transfer to a petroleum emulsion in a vessel the heater treater; a pump to circulate, propel, or pump fluid (e.g., a thermoconductive medium) through the fire tube, and to flow the thermoconductive medium past the electric heating elements to absorb heat; and a fire tube extender to fluidly couple an exhaust end (e.g., an exhaust opening, or output opening) at an upper portion (or exhaust portion) of the fire tube to an igniter end (e.g., an igniter opening) at the lower portion (or the combustion portion) of the fire tube, to route or direct fluid from the exhaust end of the fire tube to the igniter end of the fire tube.

Example 6. An assembly to electrically heat a petroleum heater treater, comprising: an electric heater to be mounted at an opening of a fire tube of a petroleum heater treater; a thermoconductive fluid to fill the fire tube, to receive heat from the electric heater, and to transfer the heat to the fire tube for heating a petroleum emulsion in a vessel of the petroleum heater treater; and a pump to circulate the thermoconductive fluid through the fire tube.

Example 7. The assembly of Example 6, wherein the electric heater is mounted at the opening of the fire tube to position one or more electric heating elements of the electric heater within the fire tube.

Example 8. The assembly of Example 6, wherein the electric heater is configured to be mounted at the opening of a lower portion of the fire tube.

Example 9. The assembly of Example 8, wherein the opening of the lower portion of the fire tube is at an igniter end of the fire tube.

Example 10. The assembly of Example 6, wherein the electric heater is configured to be mounted at the opening of an upper portion of the fire tube.

Example 11. The assembly of Example 6, further comprising: a fire tube extension to fluidly couple an exhaust end at an upper portion of the fire tube to an igniter end at the lower portion of the fire tube, to route fluid from the exhaust end of the fire tube to the igniter end of the fire tube.

Example 12. The assembly of Example 6, wherein the pump is configured to fluidly couple an opening at an upper portion of the fire tube to an opening at the lower portion of the fire tube, to route fluid from the opening at the upper portion of the fire tube to the opening at the lower portion of the fire tube.

Example 13. The assembly of Example 6, wherein the thermoconductive fluid is triethylene glycol.

Example 14. A method to convert a petroleum heater treater that is heated by a combustible heating unit to be electrically heated, comprising: removing an igniter of a combustible heating unit from a fire tube of the combustible heating unit of the petroleum heater treater, wherein the fire tube is maintained integrated with the petroleum heater treater; positioning an electric heater at a first opening of the fire tube; positioning a pump to circulate fluid through the fire tube; fluidly coupling the first opening of the fire tube to a second opening of the fire tube to permit circulation of fluid through into the first opening, through the fire tube, out the second opening, and returning to the first opening; and adding a thermoconductive medium to fill the fire tube, the thermoconductive medium to receive heat from the electric heating elements of the electric heater and to transfer the heat to the fire tube for heating a petroleum emulsion in a vessel of the petroleum heater treater.

Example 15. The method of Example 14, wherein the thermoconductive medium is triethylene glycol.

Example 16. The method of Example 14, wherein installing the electric heater comprises: positioning electric heating elements of the electric heater within the fire tube.

Example 17. The method of Example 14, wherein fluidly coupling the first opening of the fire tube to the second opening of the fire tube comprises installing a fire tube extension.

Example 18. The method of Example 14, wherein installing the pump comprises: mounting the pump at the first opening of the fire tube.

Example 19. The method of Example 14, wherein the first opening is at a lower portion of the fire tube and the second opening is at an upper portion of the fire tube.

Example 20. The method of Example 14, wherein the first opening is an igniter end at a lower portion of the fire tube and the second opening is an exhaust end at an upper portion of the fire tube.

Example 21. The method of Example 14, wherein the first opening is at an upper portion of the fire tube and the first opening is at a lower portion of the fire tube.

Example 22. The method of Example 14, further comprising: removing a fuel supply from the combustible heating unit.

Example 23. The method of Example 14, wherein the pump is mounted to fluidly couple the first opening to the second opening.

Example 24. The method of Example 14, further comprising removing an exhaust stack from the exhaust end of the fire tube.

Example 25. The method of Example 14, wherein installing the electric heater includes connecting a power supply to the heating electric heater and the pump.

Example 26. An electric heating assembly to convert a petroleum heater treater from a burner management system to electric heating, comprising: one or more electric heating elements configured to be positioned at a first opening of a fire tube of a petroleum heater treater and positioned within the fire tube; a thermoconductive medium to fill the fire tube, receive heat from the one or more electric heating elements, and transfer the heat to the fire tube for transfer to a petroleum emulsion in a vessel of the petroleum heater treater; a pump to circulate the thermoconductive medium through the fire tube; and a fire tube extender to fluidly couple a second opening of the fire tube to the first opening of the fire tube, to facilitate circulation of thermoconductive medium from the second opening to the first opening.

Example 27. The assembly of Example 26, wherein the thermoconductive fluid is triethylene glycol.

Example 28. The assembly of Example 26, wherein the pump is integral to the

fire tube extender.

Example 29. The assembly of Example 26, wherein the one or more electric heating elements is configured to be mounted at the opening of the fire tube.

Example 30. A kit to convert a petroleum heater treater to electric heating, comprising: an electric heater to be mounted at an opening of a lower portion of a fire tube to position electric heating elements of the electric heater within the fire tube; a pump to circulate fluid through the fire tube; a fire tube extension to fluidly couple an exhaust end at an upper portion of the fire tube to an igniter end at the lower portion of the fire tube; and a thermoconductive medium to fill the fire tube.

Example 31. A kit to convert a fire-tube petroleum heater treater to electric heating, comprising: one or more electric heating elements to be mounted at an opening of a lower portion of a fire tube of a petroleum heater treater to position the one or more electric heating elements within the fire tube; a pump to push fluid through the fire tube; a fire tube extension to fluidly couple an opening of an upper portion of the fire tube to the opening of the lower portion of the fire tube; and a thermoconductive fluid to fill the fire tube.

Example 32. An assembly to retrofit a fire-tube heater treater appliance to electric heating, comprising: one or more electric heating elements configured to be positioned within a fire tube of a petroleum heater treater appliance at a first opening of the fire tube, the one or more electric heating elements to heat a thermoconductive fluid within the fire tube that receives heat from the one or more electric heating elements and transfers the heat to the fire tube for transfer to a petroleum emulsion in a vessel of the petroleum heater treater appliance; a circulation pump to circulate the thermoconductive fluid within the fire tube; and a fire tube extender to fluidly couple a second opening of the fire tube to the first opening of the fire tube, to facilitate circulation of thermoconductive fluid from the second opening to the first opening.

Example 33. The assembly of Example 32, wherein the thermoconductive fluid is triethylene glycol.

While various aspects and embodiments have been disclosed herein, other aspects and embodiments are contemplated. The various aspects and embodiments disclosed herein are for purposes of illustration and are not intended to be limiting. It will be apparent to those having skill in the art that many changes may be made to the details of the above-described embodiments without departing from the underlying principles of the disclosure.

We claim:

1. An assembly to electrically heat a petroleum heater treater, comprising:
an electric heater to be mounted at an opening of a fire tube of a petroleum heater treater;
a thermoconductive fluid to fill the fire tube, to receive heat from the electric heater, and to transfer the heat to the fire tube for heating a petroleum emulsion in a vessel of the petroleum heater treater; and
a pump to circulate the thermoconductive fluid through the fire tube.

2. The assembly of claim 1, wherein the electric heater is mounted at the opening of the fire tube to position one or more electric heating elements of the electric heater within the fire tube.

3. The assembly of claim 1, wherein the electric heater is configured to be mounted at the opening of a lower portion of the fire tube.

4. The assembly of claim 3, wherein the opening of the lower portion of the fire tube is at an igniter end of the fire tube.

5. The assembly of claim 1, wherein the electric heater is configured to be mounted at the opening of an upper portion of the fire tube.

6. The assembly of claim 1, further comprising:
a fire tube extension to fluidly couple an exhaust end at an upper portion of the fire tube to an igniter end at the lower portion of the fire tube, to route fluid from the exhaust end of the fire tube to the igniter end of the fire tube.

7. The assembly of claim 1, wherein the pump is configured to fluidly couple an opening at an upper portion of the fire tube to an opening at the lower portion of the fire tube, to route fluid from the opening at the upper portion of the fire tube to the opening at the lower portion of the fire tube.

8. A method to convert a petroleum heater treater that is heated by a combustible heating unit to be electrically heated, comprising:
removing an igniter of a combustible heating unit from a fire tube of the combustible heating unit of the petroleum heater treater, wherein the fire tube is maintained integrated with the petroleum heater treater;
positioning an electric heater at a first opening of the fire tube;
positioning a pump to circulate fluid through the fire tube;
fluidly coupling the first opening of the fire tube to a second opening of the fire tube to permit circulation of fluid through into the first opening, through the fire tube, out the second opening, and returning to the first opening; and
adding a thermoconductive medium to fill the fire tube, the thermoconductive medium to receive heat from the electric heating elements of the electric heater and to transfer the heat to the fire tube for heating a petroleum emulsion in a vessel of the petroleum heater treater.

9. The method of claim 8, wherein installing the electric heater comprises:
positioning electric heating elements of the electric heater within the fire tube.

10. The method of claim 8, wherein fluidly coupling the first opening of the fire tube to the second opening of the fire tube comprises installing a fire tube extension.

11. The method of claim 8, wherein installing the pump comprises:
mounting the pump at the first opening of the fire tube.

12. The method of claim 8, wherein the first opening is at a lower portion of the fire tube and the second opening is at an upper portion of the fire tube.

13. The method of claim 8, wherein the first opening is at an upper portion of the fire tube and the first opening is at a lower portion of the fire tube.

14. The method of claim 8, further comprising:
removing a fuel supply from the combustible heating unit.

15. The method of claim 8, wherein the pump is mounted to fluidly couple the first opening to the second opening.

16. The method of claim 8, further comprising removing an exhaust stack from the exhaust end of the fire tube.

17. The method of claim 8, wherein installing the electric heater includes connecting a power supply to the heating electric heater and the pump.

18. An electric heating assembly to convert a petroleum heater treater from a burner management system to electric heating, comprising:
one or more electric heating elements configured to be positioned at a first opening of a fire tube of a petroleum heater treater and positioned within the fire tube;
a thermoconductive medium to fill the fire tube, receive heat from the one or more electric heating elements, and transfer the heat to the fire tube for transfer to a petroleum emulsion in a vessel of the petroleum heater treater;
a pump to circulate the thermoconductive medium through the fire tube; and
a fire tube extender to fluidly couple a second opening of the fire tube to the first opening of the fire tube, to facilitate circulation of thermoconductive medium from the second opening to the first opening.

19. The assembly of claim 18, wherein the pump is integral to the fire tube extender.

20. The assembly of claim 18, wherein the one or more electric heating elements is configured to be mounted at the opening of the fire tube.
